(19) United States
(12) Patent Application Publication
(10) Pub. No.: US 2016/0189369 A1
(43) Pub. Date: Jun. 30, 2016

(54) METHOD AND SYSTEM FOR DETECTING DEFECTS

(71) Applicant: SAMSUNG ELECTRONICS CO., LTD., Suwon-si (KR)

(72) Inventors: Jae-Ouk JUNG, Busan (KR); Woo-Seok KO, Seoul (KR); Yu-Sin YANG, Seoul (KR); Sang-Kil LEE, Yongin-si (KR); Chung-Sam JUN, Suwon-si (KR)

(21) Appl. No.: 14/967,943

(22) Filed: Dec. 14, 2015

(30) Foreign Application Priority Data
Dec. 31, 2014 (KR) 10-2014-0195236

(51) Int. Cl. G06T 7/00; G02B 21/00

(52) U.S. Cl. CPC G06T 7/0006; G02B 21/0028; G02B 21/008; G02B 21/0056

(57) ABSTRACT

A defect detecting method includes generating an actual image of a pattern on a sample based on irradiation of an electron beam onto the sample, performing a contrast conversion of the actual image to generate a conversion image representing a normal pattern, matching the conversion image and a design image for the pattern, and detecting a defective pattern in the actual image based on matching of the conversion image and the design image. The contrast conversion may be performed for gray levels of pixels in the actual image.

### CROSS-REFERENCE TO RELATED APPLICATION

Korean Patent Application No. 10-2014-0195236, filed on Dec. 31, 2014, and entitled, “Method and System for Detecting Defects,” is incorporated by reference herein in its entirety.

### BACKGROUND

1. Field

One or more embodiments described herein relate to a method and system for detecting defects.

2. Description of the Related Art

Efforts are continually being made to reduce the size of semiconductor devices. One approach involves the use of vertical memory devices with contact structures having a high aspect ratio. Real-time monitoring inspections technologies have been used in an attempt to detect failures or defects relating to these contacts.

### SUMMARY

In accordance with one or more embodiments, a defect detecting method includes generating an actual image of a pattern on a sample based on irradiation of an electron beam onto the sample; performing a contrast conversion of the actual image to generate a conversion image representing a normal pattern, the contrast conversion performed for gray levels of pixels in the actual image; matching the conversion image and a design image for the pattern; and detecting a defective pattern in the actual image based on matching of the conversion image and the design image.

The actual image may be a scanning electron microscope (SEM) image generated based on detection of secondary electrons emitted from the sample. The contrast conversion may be include converting the gray levels of pixels equal to or less than a predetermined gray level in the actual image to a gray level of zero. The method may include adjusting brightness or Gaussian blur of the conversion image to generate a corrected conversion image. Matching the conversion image and the design image for the pattern may include matching the corrected conversion image and the design image for the pattern. The sample may include a material layer having a contact hole. The design image may be a graphic data system (GDS) image.

In accordance with one or more other embodiments, a defect detecting method includes generating an actual image of a sample having a pattern based on irradiation of an electron beam onto the sample; performing a contrast conversion to generate a conversion image representing a normal pattern, the contrast conversion performed for gray levels of pixels in the actual image; generating a corrected conversion image based on an adjustment of brightness or Gaussian blur of the conversion image; and matching the corrected conversion image and a design image for the pattern to detect a defective pattern in the actual image.

The actual image may be a scanning electron microscope (SEM) image generated based on detection of secondary electrons emitted from the sample. The contrast conversion may include converting pixels having gray levels of a predetermined level or less in the actual image to have a gray level of zero. The sample may include a material layer having a contact hole. The design image may include a graphic data system (GDS) image.

In accordance with one or more other embodiments, a defect detecting system includes an electron microscope irradiating an electron beam onto a sample having a pattern; a detector to detect electrons emitted from the pattern to obtain an actual image for the pattern; and an image processor connected to the electron microscope, the image processor including: image converting logic to convert the actual image to a conversion image representing normal patterns, the image converting logic to perform a contrast conversion with respect to gray levels of pixels in the actual image, and matching logic to match the conversion image and a design image for the pattern to detect a defective pattern in the actual image.

The image converting logic may include a converter to convert pixel values having gray levels of a predetermined level or less in the actual image to zero to create the conversion image; and a corrector to adjust brightness or Gaussian blur of the conversion image to create a corrected conversion image. The matching logic may match the corrected conversion image and the design image for the pattern to detect a defective pattern.

In accordance with one or more other embodiments, a defect detecting method includes receiving a first image of a pattern on a sample; converting the first image to a second image including a normal pattern, the first image converted by converting gray levels of pixels in the first image that are equal to or less than a predetermined level to a predetermined value; matching the second image and a design image for the pattern; and detecting a defect in the first image based on results of the matching. The predetermined value may be a gray level equal to zero. The method further includes adjusting brightness or Gaussian blur of the second image before matching the second image and the design image. The sample may include a semiconductor device and the defect may correspond to a defect of a contact hole in the semiconductor device.

### BRIEF DESCRIPTION OF THE DRAWINGS

Features will become apparent to those of skill in the art by describing in detail exemplary embodiments with reference to the attached drawings in which:

FIG. 1 illustrates an embodiment of a defect detecting system;

FIG. 2 illustrates an embodiment of an image processing unit;

FIG. 3 illustrates an embodiment of an image creating method;

FIG. 4A illustrates an example of a scanning electron microscope (SEM) image,

FIG. 4B illustrates an example of a conversion image, FIG. 4C illustrates an example of a corrected conversion image, and FIG. 4D illustrates an example of the corrected conversion image matched with a design image;

FIG. 5 illustrates an arrangement of cells in one embodiment of a vertical semiconductor device;

FIGS. 6, 7, 8, 10 and 11A-11D illustrate examples of cross-sectional views of the vertical semiconductor device;

FIG. 9 illustrates a plan view of the vertical semiconductor device in FIG. 8; and

FIG. 11A illustrates another example of a SEM image, FIG. 11B illustrates an example of a conversion image, FIG. 11C illustrates an example of a corrected conversion image, and FIG. 11D illustrates an example of the corrected conversion image matched with a design image.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers. or one or more intervening layers may also be present. Like reference numerals refer to like elements throughout.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

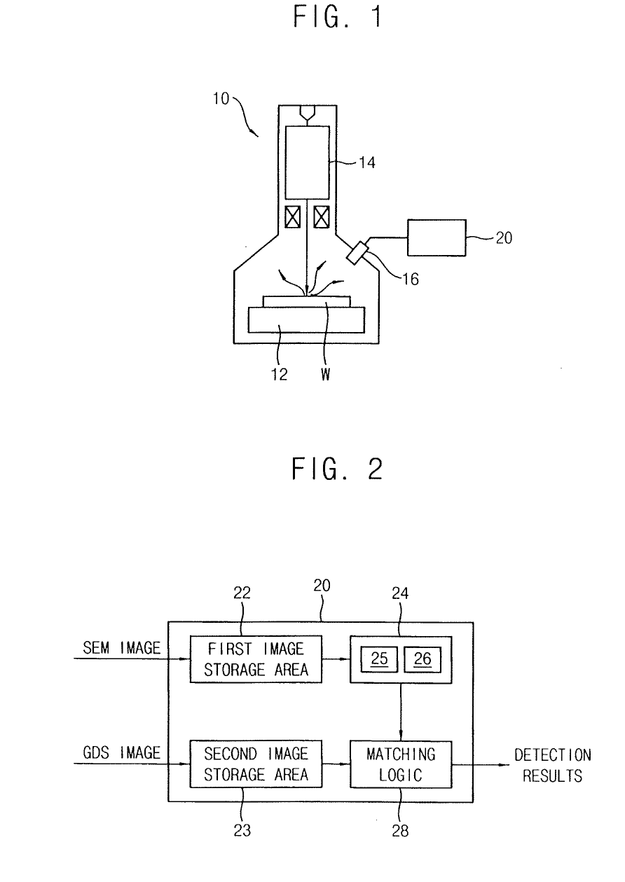

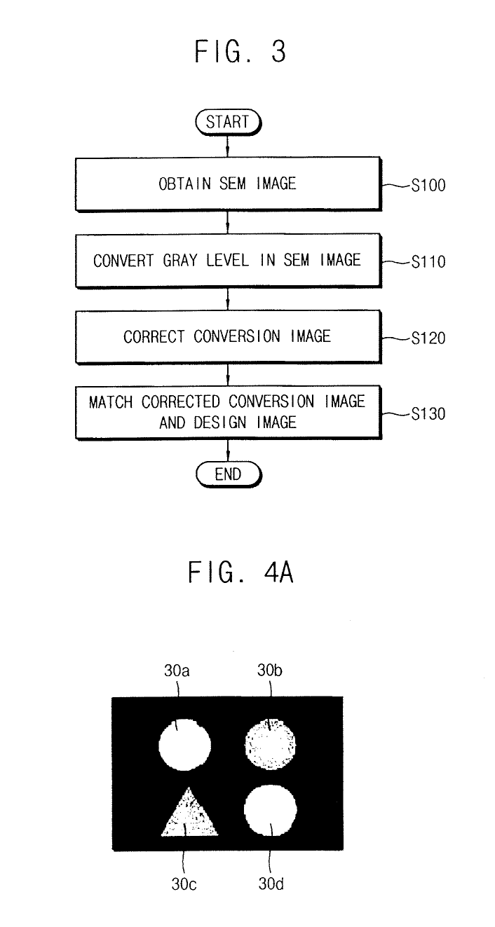

FIG. 1 illustrates an embodiment of a defect detecting system, and FIG. 2 illustrates an embodiment of an image processing unit 20. The defect detecting system includes an electron microscope 10 which irradiates an electron beam onto a sample, e.g., a semiconductor wafer W having a pattern formed thereon. The electron microscope 10 detects electrons emitted from the pattern on the wafer in order to obtain an actual image of the pattern.

The image processing unit 20 is connected to the electron microscope 10 for comparing the actual image and a design image for the pattern to detect a defective pattern on the wafer W. The image processing unit 20 includes image converting logic 24 for converting the actual image to a conversion image representing only normal patterns. The conversion may involve performing a contrast conversion with respect to a gray level of each pixel in the actual image. The image processing unit 20 includes matching logic 28 to match the conversion image and design image for detecting a defective pattern.

In one embodiment, the defect detecting system is used to inspect a pattern on a wafer in a nondestructive manner during a process for manufacturing semiconductor devices. The semiconductor devices may be, for example, a DRAM, VNAND, etc. The system may perform, for example, in-line process monitoring during semiconductor processes performed for the semiconductor wafer.

Referring to FIG. 1, the electron microscope 10 may be a scanning electron microscope (SEM) for imaging a sample such as a wafer W having a multi-layered structure. The electron microscope includes a stage 12 for supporting the wafer W, and an electron beam column 14 having an electron gun for generating a primary electron beam and an electron optical system for controlling a direction and a width of the primary electron beam and irradiating the electron beam onto the wafer W. The electron microscope may include a detector 16 for detecting electrons emitting from the wafer W.

The sample may be, for example, a semiconductor wafer including a multi-layered structure. The wafer may be a substrate formed of a semiconductor or non-semiconductor material. The wafer may include one or more layers on the substrate. The layers may include, for example, a dielectric material and/or a conductive material.

In one embodiment, an acceleration voltage of the electron beam generated by the electron gun may be adjusted to high voltage or low voltage to control the depth to which the electron beam penetrates into the sample. For example, the electron gun may generate an electron beam having a high acceleration voltage of about 10 kV or more. As the acceleration voltage of the electron beam is increased, the penetration depth of the electron beam may be increased. Thus, the amount of electrons emitted from an underlying layer of the sample may be increased. The electrons may provide an indication of various qualities of the underlying structure.

In one embodiment, the electron microscope may include high resolution scanning electron beam (HRSEM) for irradiating an electron beam having a high acceleration voltage. When the electron beam is irradiated onto the sample, secondary electrons, backscattered electrons, auger electrons, etc., may be emitted from the sample.

The detector 16 may mainly detect the secondary electrons and the backscattered electrons, to thereby obtain a SEM image representing the sample surface. The SEM image may be a spatial image having two-dimensional (2D) spatial information, e.g., the SEM image may represent the structure of the multi-layers on the sample. The detector 16 may obtain an actual image representing, for example, a hole pattern such as a contact hole of high aspect ratio.

Referring to FIG. 2, the image processing unit 20 includes a first image storage area 22, a second image storage area 23, the image converting logic 24, and the matching logic 28. The first image storage area 22 receives and stores a SEM image output from the detector 16. The second image storage area 23 receives a design image for the pattern formed on the sample, for example, from a data storage device. The design image may be, for example, a data image for determining the layout of a pattern. In one embodiment, the design image may include a graphic data system (GDS) image as the storage format of the layout.

The image converting logic 24 performs contrast conversion with respect to a gray level of pixels in the SEM image. The contrast conversion is performed to obtain a conversion image representing normal patterns. The conversion image may be compensated to generate a compensated conversion image. The image converting logic 24 may include a converter 25 and a corrector 26. The converter converts pixel values, having one or more predetermined gray levels or less of the pixels in the SEM image, to zero in order to create the conversion image. The corrector 26 adjusts the brightness or Gaussian blur of the conversion image to create a corrected conversion image.

The converter 25 may select a specific gray level distribution in the SEM image and separate and remove pixels, except the selected gray level distribution, to create the conversion image. For example, the converter 25 may perform a contrast conversion on the SEM image within a gray level range of 0 to 255, so that some pixels having a predetermined gray level (e.g., a critical value) or less may be converted to a gray level of 0 (or another predetermined gray level). Other pixels greater than the critical value may remain unconverted. As a result, the conversion image is created. Since the pixels having the critical value or less are defined to represent a defect and are removed from the conversion image, the conversion image may be an image representing only one or more normal patterns. The critical value may be selected, for example, in consideration of the thickness of the pattern, materials of the pattern, and/or the amount of the detected electrons.

The corrector 26 may increase the size of the pattern image downsized by the converter 25 and may filter the enlarged image to create the corrected conversion image. For example, the corrector 26 may adjust brightness or Gaussian blur of the conversion image to compensate the conversion image.

The matching logic 28 matches the corrected conversion image and the design image for the pattern, to detect at least one defective pattern. The corrected conversion image and the design image may be matched, for example, using an image edge matching method or an image contrast matching method.

The image processing unit 20 may be operatively connected to an output portion. The images and detection result values may be transmitted from the image processing unit 20 to the output portion. The output portion may display the detection result values on a display device.

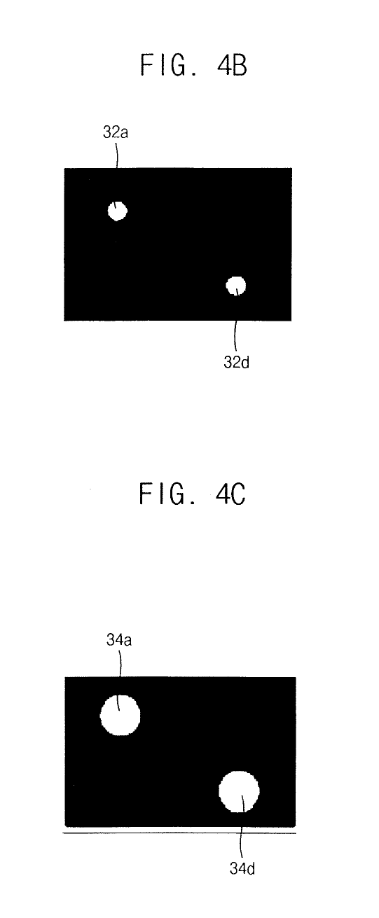

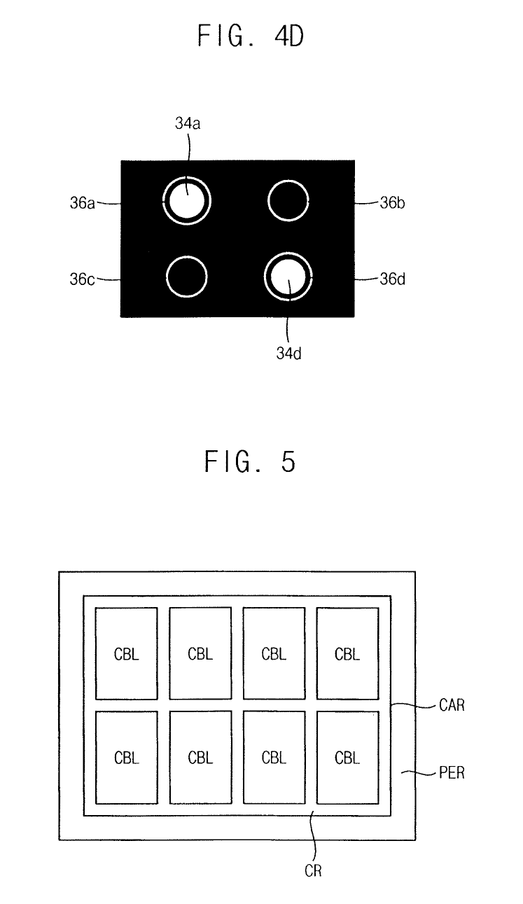

FIG. 3 illustrates an embodiment of an image creating method, FIG. 4A illustrates an example of a SEM image obtained from a pattern on a wafer, FIG. 4B illustrates an example of a conversion image converted from the SEM image in FIG. 4A, FIG. 4C illustrates an example of a corrected conversion image compensated from the conversion image in FIG. 4B, and FIG. 4D illustrates an example of the corrected conversion image in FIG. 4C matched with a design image.

Referring to FIGS. 1 to 4D, the method includes irradiating an electron beam on a pattern formed on a wafer W to obtain an actual image for the pattern (S100). The pattern may be formed, for example, by one or more semiconductor manufacturing processes for manufacturing semiconductor devices such as DRAM, VNAND, etc. According to one example, an insulation interlayer may be formed to cover step-shaped conductive patterns on a silicon substrate. The insulation interlayer may then be etched to form a plurality of contact holes to expose the conductive patterns. The conductive patterns may have different vertical heights. In one embodiment, one or more of the contact holes have a high aspect ratio, e.g., at least 1:5.

The electron microscope 10 is used to obtain the SEM image, in FIG. 4A, for the contact holes on the wafer. In the example under consideration, the SEM image may include images of normal contact holes 30a and 30d and images of defective contact holes 30b and 30c.

Then, a contrast conversion may be performed with respect to a gray level of pixels in the SEM image. The contrast conversion is performed to generate a conversion image representing only normal patterns on the wafer (S110).

A specific gray level distribution in the SEM image in FIG. 4A may be selected and pixels, except for the selected gray level distribution, may be separated and removed to create the conversion image in FIG. 4B. Pixels having gray levels below the specific gray level may be defined to represent a portion of a defective pattern, and then may be removed so that the conversion image may represent only normal pattern(s).

For example, the SEM image having pixels with levels, for example, in a gray level range of 0 to 255 may be converted so that pixels having gray levels of 1 to 254 (gray colors) may be converted to have a gray level of 0 (black color) and pixels having a gray level of 255 (white color) may remain unconverted. As a result, the conversion image is created. Thus, in this case, the pixels, except for the white color pixels, may be converted to black color so that they may be removed from the conversion image.

The conversion image in FIG. 4B include contact holes 32a and 32d represented by a white color. The SEM image may be converted such that some pixels having a predetermined gray level (e.g., a critical value) or less, for example, a gray level of 196 or less, may be converted to a gray level of 0. Other pixels having gray levels greater than the critical value, for example, gray levels greater than 196, may remain unconverted. As a result the conversion image is created.

Then, brightness or Gaussian blur of the conversion image may be adjusted to obtain a corrected conversion image (S120). The size of the downsized pattern image in the conversion image in FIG. 4B may be increased and filtered to create the corrected conversion image. For example, brightness or Gaussian blur of the conversion image may be adjusted to compensate the conversion image. The corrected conversion image in FIG. 4C may include enlarged images of normal contact holes 34a and 34d.

Then, the corrected conversion image and a design image for the pattern may be matched, or compared, to detect a defective pattern (S130). As illustrated in FIG. 4D, a GDS image for the pattern and the corrected conversion image may be matched to detect a defective pattern. The GDS image may include design images of all contact holes 36a, 36b, 36c, and 36d, and the corrected conversion image may include the images of the normal contact holes 34a and 34d. Accordingly, the contact holes 30b and 30c may be determined as a defective pattern as a result of the matching operation.

As mentioned above, according to one embodiment, a defect detecting method and defect detecting system is provided in which an SEM image for a pattern is image processed to create a conversion image representing a defective pattern. The conversion image and a GDS image may then be matched to precisely detect a defect of the pattern.

The defect detecting method may therefore be used, for example, to in-line process monitor semiconductor processes performed on a wafer. Further, the defect detecting method may be applied to a Die-to-DB system, where a pattern image in a region of interest (ROI) and a GDS image are compared.

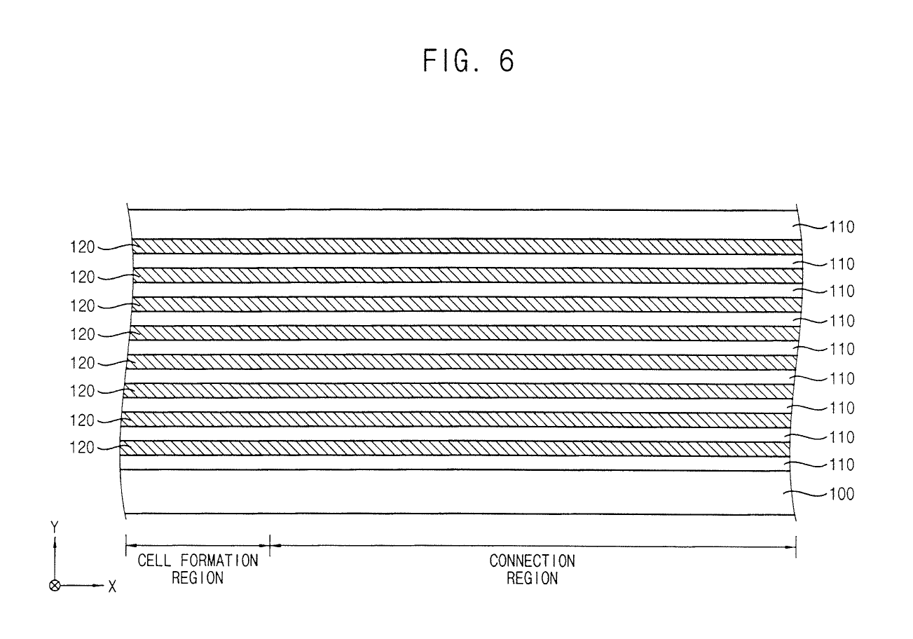

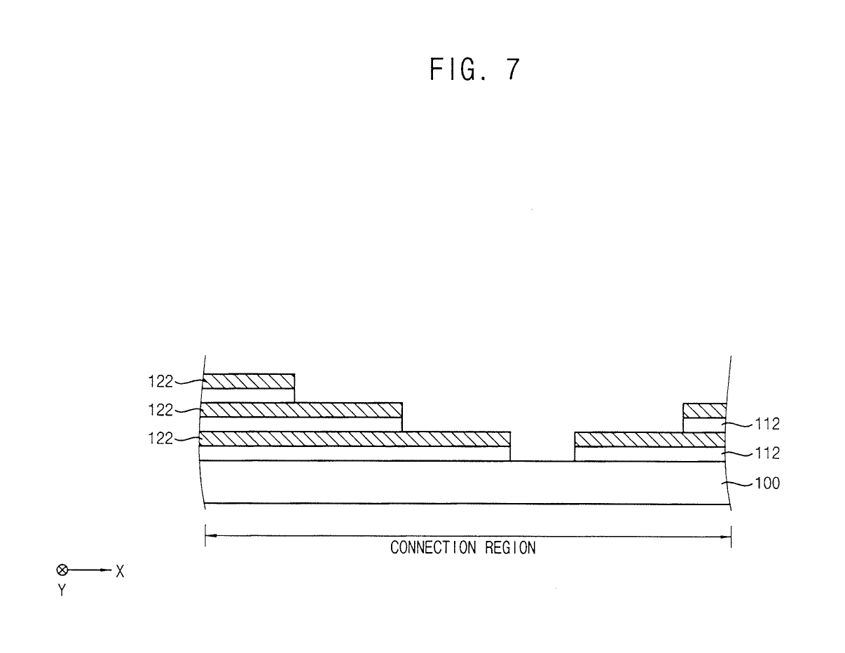

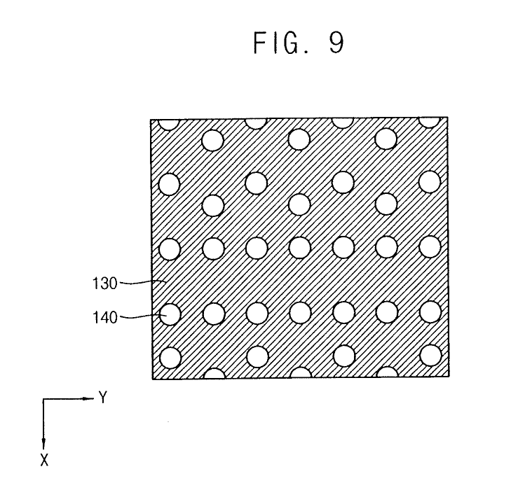

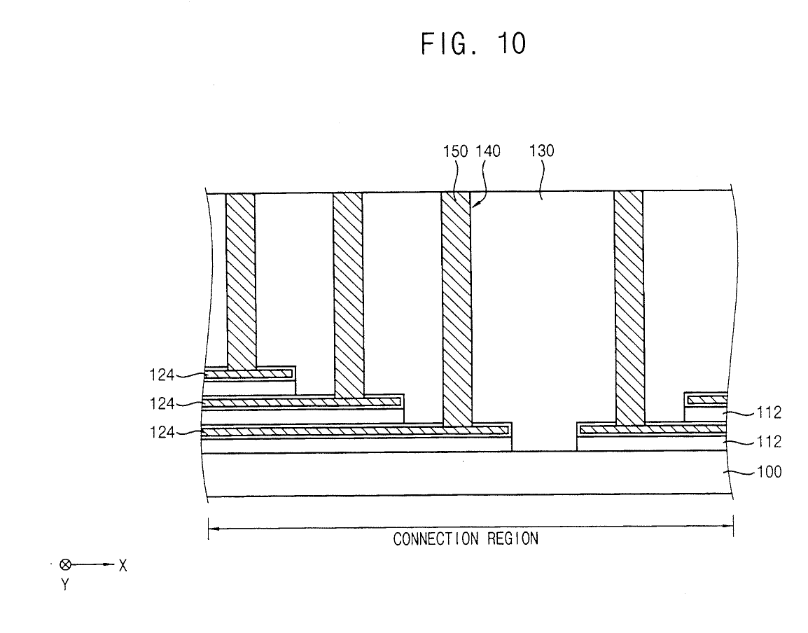

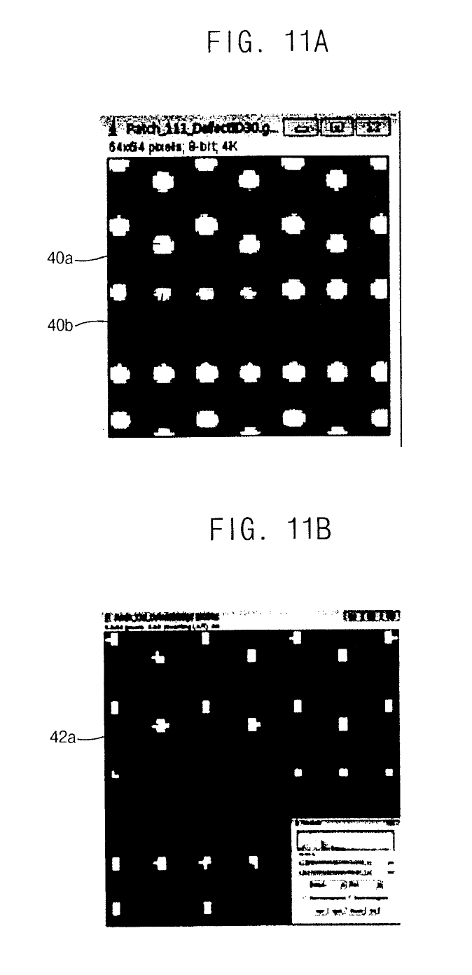

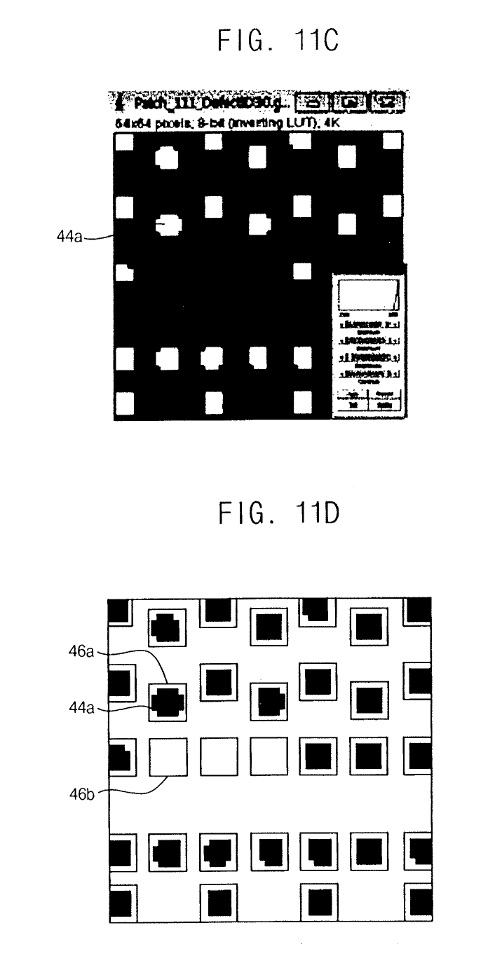

FIG. 5 illustrates an example of an arrangement of cells in a vertical semiconductor device. FIGS. 6, 7, 8, 10, and 11 are cross-sectional views illustrating the vertical semiconductor device in accordance with example embodiments. FIG. 9 is a plan view the vertical semiconductor device in FIG. 8. FIG. 11A illustrates an example of an SEM image obtained from a pattern on the semiconductor substrate in FIG. 9. FIG. 11B illustrates an example of a conversion image converted from the SEM image in FIG. 11A. FIG. 11C illustrates an example of a corrected conversion image compensated from the conversion image in FIG. 11B. FIG. 11D illustrating an example of the corrected conversion image in FIG. 11C matched with a design image.

Referring to FIG. 5, a vertical semiconductor device may include a cell array region CAR including one or more memory cells and a peripheral circuit region PER including circuits for operating the memory cells. The cell array region CAR includes cell blocks CBL and a connection region CR. Each cell block CBL includes memory cells connected to conductive lines extending from the memory cells to the connection region CR.

Referring to FIG. 6, a semiconductor substrate 100 may be prepared to include a cell region having memory cells and a peripheral region having peripheral circuits. The cell region may include a cell formation region and a connection region. The cell formation region includes the memory cells and the connection region includes wires electrically connected to the memory cells. The semiconductor substrate 100 may include a single crystalline silicon substrate.

Insulating interlayers 110 and sacrificial layers 120 may be sequentially and repeatedly stacked on the semiconductor substrate 100. The insulating interlayers 110 may be formed, for example, by depositing silicon oxide layers. The sacrificial layers 120 may include, for example, a material having etch selectivity with respect to the insulating interlayers 110. For example, the sacrificial layers 120 may be silicon nitride layers. This embodiment includes eight sacrificial layers 120 and nine insulating interlayers 110. A different number of sacrificial and/or insulting interlayers may be included in another embodiment.

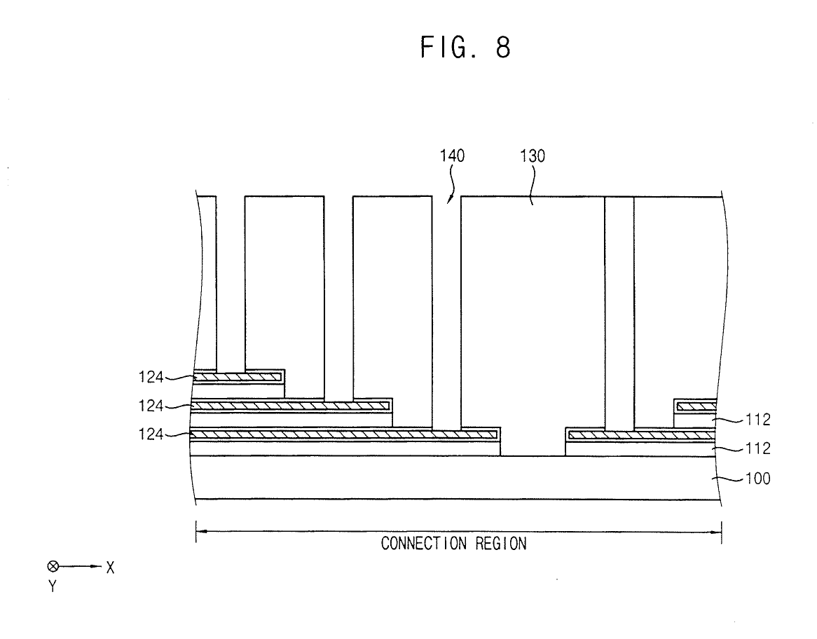

Referring to FIG. 7, the sacrificial layers 120 and the insulating interlayers 110 may be patterned through a photolithographic process to form a step-shaped structure, in which insulating interlayer patterns 112 and sacrificial layer patterns 122 are stacked. To form this structure, the photolithographic process and an etching process may be performed several times.

Referring to FIG. 8, an upper insulating interlayer 130 may be formed on the resulting structure of FIG. 7. The upper insulating interlayer may include, for example, a silicon oxide layer. A planarizing process may be performed to planarize an upper surface of the upper insulating interlayer.

Then, a plurality of channel holes may be formed in the cell formation region, and then a channel layer may be conformally formed on sidewalls of the channel holes. The insulating interlayer patterns 112 and the sacrificial layer patterns 122, which are formed between the channel layers, may be etched to form opening portions. Then, the sacrificial layer patterns 122 which are exposed to a sidewall of the opening portion may be removed to from grooves between the insulating interlayer patterns.

Then, a tunnel insulating layer, a charge trap layer, and a blocking dielectric layer may be sequentially formed along inner surfaces of the groove and the opening portions. A conductive layer may be formed on the blocking dielectric layer. In one embodiment, the conductive layer may be fully filled in the groove. The conductive layer may be deposited using a conductive material having the superior step coverage characteristic to suppress the occurrence of voids. The conductive material may include metal. For instance, the conductive material may include, for example, a material having low electric resistance, e.g., tungsten, tungsten nitride, titanium, titanium nitride, tantalum, tantalum nitride, or platinum. In one embodiment, a barrier metal layer including, for example, titanium, titanium nitride, tantalum or tantalum nitride may be formed, and then a metal layer including, for example, tungsten, may be formed thereon.

Then, a conductive layer formed in the opening portion may be etched to form control gate electrodes 124 having a dual-layer structure in the groove. The control gate electrodes may be provided as word lines.

Referring to FIGS. 8 to 10, the upper insulating interlayer may be partially etched to form contact holes 140 which expose top surfaces of the word lines. Then, contact plugs 150 may be formed in the contact holes 140.

A hard mask layer may be formed on the upper insulating interlayer 130 and patterned to form a hard mask pattern. Then, the upper insulating interlayer may be etched using the using the hard mask pattern as an etch mask.

A barrier metal layer and a metallic material may be deposited in the contact holes and a planarization process may be performed. The barrier metal layer may include, for example, titanium, titanium nitride, tantalum, tantalum nitride, or tungsten nitride. The metallic material may include, for example, tungsten, copper, or aluminum. A process of depositing the metallic material may include, for example, chemical vapor deposition, physical vapor deposition, or electroplating. A material (e.g., tungsten) may be formed in the contact hole using the chemical vapor deposition.

Then, wire lines may be formed to contact upper surfaces of the contact plugs 150, respectively, to complete the vertical semiconductor device with contact structures.

Referring again to FIG. 9, upper surfaces of the word lines may be exposed by the contact holes 140. However, a failure may occur where the word line having a predetermined depth is not exposed by a defective one of the contact holes 140.

FIGS. 11A to 11D illustrate different stages of an embodiment of the method for detecting a defective contact hole described with reference to FIGS. 3 and 4. Referring to FIG. 11A, a SEM image may be obtained from the semiconductor substrate in FIG. 9. The SEM image may be obtained by detecting electrons emitted from the pattern on the semiconductor substrate. The SEM image may have different gray levels corresponding to the number of detected electrons based on whether or not the underlying word line is exposed by the contact hole. Accordingly, the SEM image in FIG. 11A may include an image of a normal contact hole 40a and an image of a defective contact hole 40b.

Referring to FIG. 11B, a specific gray level distribution in the SEM image in

FIG. 11A may be selected and pixels, except for the selected gray level distribution, may be separated and removed to create a conversion image in FIG. 11B. The pixels below the specific gray level may be defined to represent a portion of a defective pattern and then may be removed, so that the conversion image may represent only a normal pattern.

For example, the SEM image having pixel values in a gray level range of 0 to 255 may be converted such that pixels having a gray level of 1 to 254 (gray color) may be converted to have a gray level of 0 (black color) and pixels having a gray level of 255 (white color) may remain unconverted. A conversion image may therefore be created. In this case, the pixels, except for the white color pixels, may be converted to a black color to thereby be removed from the conversion image. The conversion image in FIG. 11B include images of the contact holes 42a representing a white color. The SEM image may be converted such that some pixels having a predetermined gray level (critical value) or less may be converted to have a gray level of 0. Other pixels having gray levels greater than the critical value may remain unconverted to create the conversion image.

Referring to FIG. 11C, the size of the downsized pattern image in the conversion image in FIG. 11B may be increased and filtered to create a corrected conversion image. For example, brightness or Gaussian blur of the conversion image may be adjusted to compensate the conversion image. The corrected conversion image in FIG. 11C may include enlarged images of normal contact holes 44a.

Referring to FIG. 11D, a GDS image for the contact hole and the corrected conversion image may be matched to detect a defective contact hole. The GDS image may include design images of all contact holes 46a and 46b, and the corrected conversion image may include the images of the normal contact holes 44a. Accordingly, the contact holes 40b may be determined as a defective pattern by the matching operation.

The methods, processes, and/or operations described herein may be performed by code or instructions to be executed by a computer, processor, logic, controller, or other signal processing device. The computer, processor, logic, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

In one or more embodiments, the operations of the methods or the features of the systems described herein may be implemented in logic which, for example, may include hardware, software, or both. When implemented at least partially in hardware, the operations of the methods or features of the system may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the operations of the method or features of the system may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

By way of summation and review, vertical memory devices (e.g., VNANDs) may include contact structures having high aspect ratio. Some of these contact structures may be defective. In accordance with one or more embodiments, a defect detecting method and system are provided in which a SEM image for a pattern is processed to create a conversion image representing whether or not a defective pattern exists. The conversion image and a GDS image are then matched, or compared, to precisely detect a defect of the pattern. This method and system may be used, for example, to in-line process monitor semiconductor processes performed on a wafer.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A defect detecting method, the method comprising:
generating an actual image of a pattern on a sample based on irradiation of an electron beam onto the sample;
performing a contrast conversion of the actual image to generate a conversion image representing a normal pattern, the contrast conversion performed for gray levels of pixels in the actual image;
matching the conversion image and a design image for the pattern; and
detecting a defective pattern in the actual image based on matching of the conversion image and the design image.

2. The method as claimed in claim 1, wherein the actual image is a scanning electron microscope (SEM) image generated based on detection of secondary electrons emitted from the sample.

3. The method as claimed in claim 1, wherein the contrast conversion includes converting the gray levels of pixels equal to or less than a predetermined gray level in the actual image to a gray level of zero.

4. The method as claimed in claim 1, further comprising:
adjusting brightness or Gaussian blur of the conversion image to generate a corrected conversion image.

5. The method as claimed in claim 4, wherein matching the conversion image and the design image for the pattern includes matching the corrected conversion image and the design image for the pattern.

6. The method as claimed in claim 1, wherein the sample includes a material layer having a contact hole.

7. The method as claimed in claim 1, wherein the design image is a graphic data system (GDS) image.

8. A defect detecting method, the method comprising:
generating an actual image of a sample having a pattern based on irradiation of an electron beam onto the sample;
performing a contrast conversion to generate a conversion image representing a normal pattern, the contrast conversion performed for gray levels of pixels in the actual image;
generating a corrected conversion image based on an adjustment of brightness or Gaussian blur of the conversion image; and
matching the corrected conversion image and a design image for the pattern to detect a defective pattern in the actual image.

9. The method as claimed in claim 8, wherein the actual image is a scanning electron microscope (SEM) image generated based on detection of secondary electrons emitted from the sample.

10. The method as claimed in claim 8, wherein the contrast conversion includes converting pixels having gray levels of a predetermined level or less in the actual image to have a gray level of zero.

11. The method as claimed in claim 8, wherein the sample includes a material layer having a contact hole.

12. The method as claimed in claim 8, wherein the design image includes a graphic data system (GDS) image.

13. A defect detecting system, comprising:
an electron microscope irradiating an electron beam onto a sample having a pattern;
a detector to detect electrons emitted from the pattern to obtain an actual image for the pattern; and
an image processor connected to the electron microscope, the image processor including:
image converting logic to convert the actual image to a conversion image representing normal patterns, the image converting logic to perform a contrast conversion with respect to gray levels of pixels in the actual image, and
matching logic to match the conversion image and a design image for the pattern to detect a defective pattern in the actual image.

14. The system as claimed in claim 13, wherein the image converting logic includes:
a converter to convert pixel values having gray levels of a predetermined level or less in the actual image to zero to create the conversion image; and
a corrector to adjust brightness or Gaussian blur of the conversion image to create a corrected conversion image.

15. The system as claimed in claim 14, wherein the matching logic is to match the corrected conversion image and the design image for the pattern to detect a defective pattern.

16. A defect detecting method, the method comprising:
receiving a first image of a pattern on a sample;
converting the first image to a second image including a normal pattern, the first image converted by converting gray levels of pixels in the first image that are equal to or less than a predetermined level to a predetermined value;
matching the second image and a design image for the pattern; and
detecting a defect in the first image based on results of the matching.

17. The defect detecting method as claimed in claim 16, wherein the predetermined value is a gray level equal to zero.

18. The defect detecting method as claimed in claim 16, further comprising:
adjusting brightness or Gaussian blur of the second image before matching the second image and the design image.

19. The defecting detecting method as claimed in claim 16, wherein:
the sample includes a semiconductor device, and
the defect corresponds to a defect of a contact hole in the semiconductor device.
